(19) United States
(12) Patent Application Publication
(10) Pub. No.: US 2015/0314665 A1
(43) Pub. Date: Nov. 5, 2015

(54) SECURING CLAMP FOR A HEAT EXCHANGER BOTTLE, NOTABLY MOTOR VEHICLE AIR CONDITIONING CIRCUIT CONDENSER

(71) Applicant: VALEO SYSTEMES THERMIQUES, Le Mesnil Saint-denis (FR)

(72) Inventor: Gaël DURBECQ, Reims (FR)

(73) Assignee: Valeo Systemes Thermiques, Le Mesnil Saint Denis (FR)

(21) Appl. No.: 14/652,489

(22) PCT Filed: Dec. 12, 2013
(86) PCT No.: PCT/EP2013/076408

§ 371 Date: Jun. 16, 2015

(30) Foreign Application Priority Data
Dec. 20, 2012 (FR) 1262450

(51) Int. Cl. B60H 1/00; F16B 2/22

(52) U.S. Cl. CPC B60H 1/00321; B60H 1/00592; F16B 2/22

(57) ABSTRACT

A clamping flange for a bottle of a heat exchanger, notably a motor vehicle air conditioning circuit condenser, is disclosed. The flange is configured to hold said bottle firmly to the exchanger and includes a fixing tab having a first part for holding to the heat exchanger and a second part for holding to the bottle, and the flange extends between said holding parts so as to ensure that the bottle is held cantilever fashion with respect to the exchanger with a freedom in bending that allows the bottle to move away from and/or closer to the exchanger.

The invention relates to a clamping flange for a bottle of a heat exchanger, notably a motor vehicle air conditioning circuit condenser, and to a bottle comprising such a clamping flange and to a heat exchanger comprising such a bottle.

It is known that air conditioning circuit condenser bottles are generally fixed at their base to the condenser, for example parallel to a header tank thereof.

A closure bonnet for such a bottle is known, the bonnet being in the form of a cup covering the top opening of the bottle and being secured to the condenser by means of two opposite lateral lugs each one engaged on one side of the header tank. Such a bonnet has poor resistance to the movements, vibrations and knocks experienced by the condenser and this causes risks of the connection between the condenser and the bottle breaking, or even risks of imperfect sealing.

Such a connection needs to be improved and for this reason there is proposed a clamping flange for a bottle of a heat exchanger, notably a motor vehicle air conditioning circuit condenser, said flange being configured to hold said bottle firmly to the exchanger, said flange comprising a fixing tab comprising a first part for holding to the heat exchanger and a second part for holding to the bottle, said flange extending between said holding parts so as to ensure that the bottle is held cantilever fashion with respect to the exchanger with a freedom in bending that allows the bottle to move away from and/or closer to the exchanger.

In other words, said clamping flange comprises a single part for holding to the exchanger rather than the various holding parts of the clamping flanges of the prior art. This is because the applicant has discovered that the known solutions made the connection between the bottle and the exchanger too rigid, leading to a weakening of the clamping flange under the effect of the movements, vibrations and knocks experienced by the exchanger, notably in the direction, referred to as the X-direction, parallel to a longitudinal axis of the vehicle and corresponding to a direction orthogonal to the core bundle of the exchanger. Cantilevered support according to the invention on the other hand gives the clamping flange a degree of elasticity, particularly in the X-direction, that encourages absorption of said movements, vibrations or knocks.

Said bottle is, for example, of tubular overall configuration. It may be fixed at its base to the exchanger at a first fixing point. Said clamping flange is then configured to hold said bottle firmly to the condenser at a second fixing point distant from the first fixing point.

Advantageously, said holding parts are offset relative to one another angularly with respect to the axis of the bottle, for example by an angle α of between 5° and 175° or −175° and −5°. Said angle α is considered to have its sides in the middle of said holding parts and its vertex on the axis of the bottle.

Said angle α is advantageously comprised between 30° and 60° or between −60° and −30°, preferably comprised between 40° and 50° or between −50° and −40°, and more particularly close to 45° or −45°. At the latter value, the strain in the X-direction is reduced by approximately 35% according to the Goodman criterion.

In other words, such a connection by a single tab extending between said holding parts allows the clamping flange to flex laterally, notably in said direction of the vehicle in the X-direction, thereby damping vibrations in this direction and preventing the connection from breaking.

According to various embodiments of the invention, which may be considered together or separately:
said holding parts are connected by a branch wrapped around said bottle so as to have an orientation intended to be substantially tangential to a circle centered on the axis Δ of the bottle at said first holding part, and an orientation intended to be parallel to said axis Δ of the bottle at the level of said second holding part,
said branch is configured to more or less surround said bottle according to the magnitude of angle α,
said branch is conformed to be rounded near the top in order to come to meet said bottle,
said rounding is in the form of a semicircle and the radius R of the semicircle of said rounding is between 1 and 5 mm,
the height h′ between the first holding part and an inner end of said rounding is between 5 and 20 mm,
the first holding part has a height h of between 5 and 15 mm,
the width e of the second holding part is comprised between 5 and 15 mm,
said tab has a twisted S-shaped profile,
said first holding part corresponds to the base of the S,
said second holding part is the upper part of the S,
said tab is made from an aluminum-based metal, or even from an aluminum alloy, as is the bottle, so as to allow the bottle to be mounted on the exchanger by brazing.

It should be noted that said rounded configuration of the upper part of the tab gives the clamping flange an ability to flex and a resistance to mechanical strain in the Z-direction or in the vertical direction which adds to its ability to flex in the X-direction.

According to one aspect of the invention, which may be employed alone or in combination with the foregoing, said clamping flange comprises a cap that seals the bottle, notably for sealing the top opening of the bottle. This cap is preferably set into the opening of the bottle. Said second holding part is secured to said cap. Advantageously, said tab and said cap are formed together from the same material.

Said rounding of the tab may have one end contiguous with one edge of the sealing cap. In that way, said tab holds the bottle via the sealing cap mounted in said bottle opening.

The invention also relates to a bottle provided with a clamping flange as described hereinabove.

Said bottle is, for example intended to be fixed to a header tank of the exchanger and positioned adjacent and parallel to said header tank, preferably in the plane of the heat exchange core bundle of the exchanger to which said header tank is connected, or close thereto. Said tab is, for example, intended to be interposed by said first holding part between the header tank and the bottle.

The invention further relates to a heat exchanger, notably a motor vehicle air conditioning circuit condenser, comprising a bottle as described hereinabove. Advantageously, said flange is fixed to the header tank of the exchanger.

Said header tank comprises, for example, a collector plate and a cover, said cover having lateral edges, covered by lateral edges of the collector plate, and a rear face connecting said lateral edges. Said first tab holding part may at least partially hug said rear face, notably by being curved.

These features and others of the present invention will become more clearly apparent from studying the attached drawings in which:

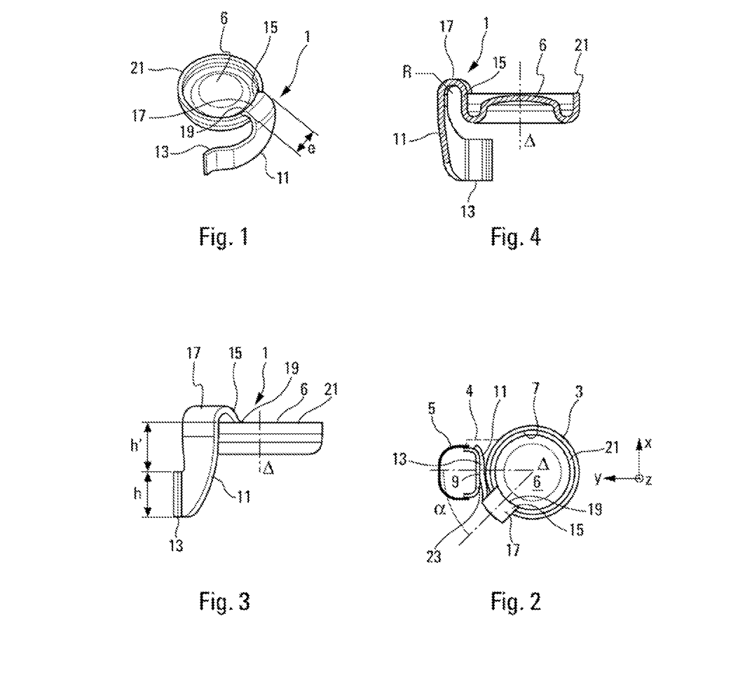

FIG. 1 is a perspective view of a clamping flange for an air conditioning circuit condenser bottle according to one embodiment of the invention;

FIG. 2 is a view from above of this clamping flange, mounted between the bottle and a header tank of the condenser, with a sealing cap mounted over the top opening of the bottle;

FIG. 3 is an elevation of this clamping flange; and

FIG. 4 is a view in cross section of the clamping flange.

In the description that follows, identical references are used to denote elements that are analogous or identical.

As illustrated in FIG. 1, the invention relates to a clamping flange 1 for holding a bottle 3 of a heat exchanger, particularly an air conditioning circuit condenser, notably for a motor vehicle.

The exchanger is of the type allowing an exchange with the air, which means to say that it comprises for example a core bundle, not depicted, of tubes for the circulation of a fluid, notably a refrigerant, between which are interposed inserts through which there passes a flow of incident air used to exchange heat with the fluid circulating through the tubes, notably for condensing it. Said core bundle is intended to be arranged for example parallel to the vehicle radiator grille opening and therefore to be perpendicular to a longitudinal plane of the vehicle, namely to a direction referred to as the X-direction.

Said core bundle may further comprise one or more header tanks 5 into which the tubes of the core bundle emerge, for example via orifices which are not visible.

The bottle 3 is, for example, a reserve of refrigerant forming a buffer of refrigerant liquid in the air conditioning circuit. It may further be configured to separate the liquid and gas phases of the refrigerant. It is, for example, of tubular shape, fixed at its base to the condenser at a first fixing point 4 in broken line, notably to said header tank 5 of the condenser as illustrated by FIG. 2. More specifically, the bottle 3 is positioned adjacent and parallel to said header tank 5, in the plane of the core bundle or nearby. The bottle may comprise connecting means intended for fixing the bottle and therefore the exchanger to a structure that acts as a support for the exchanger. For example, such connecting means are of the type of at least one fixing tab (not depicted) extending radially beyond the bottle.

In this particular instance this is a bottle fitted with a filter cartridge and/or desiccant cartridge which can be changed during the course of the life of the exchanger, notably by use of a removable plug that allows the bottle to be opened at its base.

The clamping flange 1 is provided, for example, with a cap 6 to seal the top opening 7 of the bottle and keep said bottle firmly held against the condenser at a second fixing point 9 separate from the first fixing point 4.

The clamping flange 1 comprises a single tab 11 for attachment to said header tank 5 and this is configured in such a way that said flange holds the bottle with respect to the exchanger in a cantilever fashion with a freedom to flex that allows the bottle 3 to move away from and/or closer to the exchanger. In this way, the tab can be configured to form a backsweep subject to a spring effect when faced with the mechanical actions oriented along the X axis.

Said tab 11 is made of aluminum-based metal, or even of aluminum alloy, as is the bottle, so as to allow the clamping flange 1 and the sealing cap 6 to be fitted by brazing to said header tank 5 and the bottle 3. It is also formed as a single piece with the cap 6, making the whole simpler to manufacture, for example by pressing.

Said tab comprises a first part 13 for holding to the header tank 5 and a second part 15 for holding to the bottle and it extends between said holding parts 13, 15, giving it the option of fixing the bottle to the exchanger in the aforementioned overhanging manner.

Said tab 11 is here interposed via its first holding part 13 between the header tank 5 and the bottle 3, in the space formed between the bottle 3 and the header tank 5.

Said first and second holding parts 13, 15 are angularly offset relative to the axis Δ of the bottle by an angle α of between 5° and 175° or −175° and −5°. Said angle α is defined by its sides passing through the middle of said holding parts 13, 15 and has as its vertex the projection of the axis Δ in a horizontal plane as can be seen in chain line in FIG. 2.

The connection of said clamping flange to the upper part of the bottle 3 is thus offset laterally from the axis Δ of the bottle, giving the connection relative flexibility for withstanding the movements, shocks and vibrations in a vehicle, particularly in the direction parallel to the longitudinal plane of the vehicle or the X-direction.

Said angle α is advantageously comprised between 30° and 60° or between −30° and −60°. It is preferably comprised between 40° and 50° or between −50° and −40°, and more particularly close to 45° as in the present case, or −45°. At this value of 45°, the transverse mechanical stress applied to the connection is reduced by approximately 35% according to the Goodman criteria.

The second holding part 15 of the tab, although it can be pressed against the bottle 3, advantageously bears against the cap 6. It is advantageously configured with a rounding of the top, in this instance in an upper semicircle 17 (FIG. 4), the inwardly-returned end 19 of which is joined to an edge 21 of the cap 6.

The radius R of the semicircle of the second holding part 15 is between 1 and 5 mm. This radius of curvature R contributes to said flexibility and resistance to mechanical strain in the Z-direction of the connection, namely the vertical direction in which the axis Δ of the bottle also lies.

The cap 6 is inset in a fluidtight manner into the opening 7 of the bottle. In this way, said tab 11 also keeps the closure bonnet mounted on said opening and through this configuration has the ability to flex and resist mechanical strain in the Z-direction.

Said tab 11 is cut into a twisted S profile (FIG. 3), being configured to partially surround said bottle 3 between said holding parts 13, 15 as can be seen in FIG. 2.

The first holding part 13, on the header tank 5, corresponds to the base of the S. This first holding part here is curved so as to press against the external wall 23 of the header tank 5 over part of its periphery. It has a height h of between 5 and 15 mm. This height determines the rigidity of the connection relative to the header tank.

In this instance, said cover having lateral edges covered by lateral edges of the collector plate, and a rear face connecting said lateral edges. Said first holding part 13 of the tab at least partially hugs said rear face. More specifically, it has a distal edge sandwiched between the lateral edges of the cover and of the collector plate. It extends from said distal edge against said rear face at least as far as a midplane of said collector. Said tab 11 then diverges progressively from said rear face in order to wrap around said bottle 3 via a branch connecting said holding parts 13, 15.

The second holding part 15 corresponds to the semicircular rounded upper part 17 joined to the cap 6.

The width e of this second holding part 15 is between 5 and 15 mm, this value defining a compromise between the rigidity and the flexibility of the connection to the header tank.

The same is true of the height h′ between the first holding part 13 and said inner end 19 of the second holding part 15, which is preferably comprised between 5 and 20 mm.

The invention thus supplies a clamping flange for a heat exchanger, notably a bottle of an air conditioning circuit condenser, of which the connection between the condenser and the bottle has flexibility in order to withstand the movements, vibrations and knocks in a vehicle, notably in a direction parallel or close to a longitudinal or X-direction plane of the vehicle.

1. A clamping flange for a bottle of a heat exchanger in the form of a a motor vehicle air conditioning circuit condenser, said flange being configured to hold said bottle firmly to the exchanger, said flange comprising:
a fixing tab comprising a first part for holding to the heat exchanger and a second part for holding to the bottle, said flange extending between said holding parts so as to ensure that the bottle is held cantilever fashion with respect to the exchanger with a freedom in bending that allows the bottle to move away from and/or closer to the exchanger.

2. The clamping flange as claimed in claim 1, in which said holding parts are offset relative to one another angularly with respect to an axis Δ of the bottle.

3. The clamping flange as claimed in claim 2, in which said holding parts are connected by a branch wrapped around said bottle so as to have an orientation intended to be substantially tangential to a circle centered on the axis Δ of the bottle at said first holding part, and an orientation intended to be parallel to said axis Δ of the bottle at the level of said second holding part.

4. The clamping flange as claimed in claim 3, in which said branch is conformed to be rounded near the top in order to come to meet said bottle.

5. The clamping flange as claimed in claim 4, in which said rounding is in the form of a semicircle and in which a radius of the semicircle of said rounding is between 1 and 5 mm.

6. The clamping flange as claimed in claim 4, in which a height between a capital part of the first holding part and an inner end of said rounding is between 5 and 20 mm.

7. The clamping flange as claimed in claim 1, in which the first holding part has a height of between 5 and 15 mm.

8. The clamping flange as claimed in claim 1, in which the width of the second holding part is comprised between 5 and 15 mm.

9. The clamping flange as claimed in claim 1, in which said tab has a twisted S-shaped profile.

10. The clamping flange as claimed in claim 9, in which the first holding part corresponds to the base of the S in the twisted S-shaped profile.

11. The clamping flange as claimed in claim 9, in which said second holding part is the upper part of the S in the twisted S-shaped profile.

12. The clamping flange as claimed in claim 1, comprising a closure cap that seals the bottle, and in which said second holding part is secured to said cap.

13. A bottle provided with a clamping flange as claimed in claim 1, said bottle being intended to be fixed to a header tank of the exchanger and positioned adjacent and parallel to said header tank, said tab being intended to be interposed by said first holding part between the header tank and the bottle.

14. A heat exchanger in the form of a motor vehicle air conditioning circuit condenser, comprising a bottle as claimed in claim 13.

15. The heat exchanger as claimed in claim 14, in which said header tank comprises a collector plate and a cover, said cover having lateral edges, covered by lateral edges of the collector plate, and a rear face connecting said lateral edges, said first holding part of the tab at least partially hugging said rear face.
